(19) United States
(12) Patent Application Publication
(10) Pub. No.: US 2008/0043841 A1
(43) Pub. Date: Feb. 21, 2008

(54) Method for video coding

(76) Inventors: Ching-Lung Su, Yunlin (TW); Jiun-In Guo, Chia-yi (TW); Ching-Wen Chen, Chia-Yi (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/506,800

(22) Filed: Aug. 21, 2006

(51) Int. Cl. H04N 11/02; H04N 11/04

(52) U.S. Cl. 375/240.16; 375/240.24

(57) ABSTRACT

A method of video coding is disclosed. It includes searching the candidates of a frame for decreasing the samples, and chooses the bit numbers of transmitting data for reducing the requirement of memory bandwidth. Then obtain the better candidates of moving blocks. After that, apply a method of local small range full search processing around the candidates of moving blocks for obtaining the best motion vectors.

### BACKGROUND

1. Field of Invention

The present invention relates to a method for video decoding. More particularly, the present invention relates to a method for video decoding, which applying a small range full search method, and searching candidates with a fixed interval to reduce sampling numbers.

2. Description of Related Art

H.264/AVC is the video compression standard regulated by Joint Video Team which is composed of Video Coding Experts Group in ITU-T and Moving Picture Experts Group in ISO and IEC.

This purpose of this video compression standard is being highly efficient, network friendly and with error resilience. Compared to the conventional video coding method such as MPEG-1, MPEG-2, MPEG-4 and H.263++, H.264/AVC video compression stand offers more varieties of judging modes, more complicated variable block sizes and the -searching method for multiple reference frames.

The above-mentioned technologies lead to occupation of enormous calculation of motion estimation in the conventional decoding system and increase more calculation. Therefore, to achieve the application of high definition television and the purpose of real-time decoding, it is a problem that needs to be conquered in order to enhance overall efficiency and output rate under tremendous calculation.

In the process of decoding, the accuracy of inter-frame prediction decides the quality of each frame. And the fractional motion estimation is based on the result of integral motion estimation and goes on to the next search. There fore only accurate integral motion estimation can make the whole frame quality have no distortion. In conventional chip production process, the full area search method is used as the content of hardware practice. On the one hand, the full area search method have no distortion of integral motion estimation, on the other hand, due to regular search method, the same data can be used tremendously and repeatedly in order to reduce the frequent memory accessing. But there is a fatal shortcoming in this method; that is, the cost on the hardware is great and it is time-consuming. Based on the above-mentioned reason, full area search method is not suitable for practicing on the chips whose superficial areas are getting smaller nowadays.

Therefore, it is the problem the conventional technique needs to conquer to decrease the large amount of memory access and the calculation of bandwidth requirement.

### SUMMARY

It is therefore an objective of the present invention to provide a staged integral motion estimation method in order to reduce the time spent on processing each block search when coding.

It is another an objective of the present invention to provide a video coding method on predicting the best motion vector, using the less bits that are needed and motion vector is accurate.

According to the aforementioned objective of the present invention, a two-staged method of integral motion estimation is disclosed. According to a preferred embodiment of the present invention, in the first stage, proceeds a search on a fixed candidate in every interval. By this regular search, a large amount of time consumed on the same data when accessing memory will be saved. After deciding several candidates, it still can achieve several motion vectors that are close to the best solution. The second stage aims at several candidates decided by the first stage to proceed with local small range full search. Due to the fact that the motion vectors have received the closest best solution, further search must be put on these motion vectors. According to searching all blocks, 4×4 block motion estimation must be found. Finally, pick the best 41 motion vector out of various block modes from the remaining block modes and put out to fractional motion estimation to proceed more accurate prediction.

According to another objective of the present invention, a video coding method of predicting best motion vector is disclosed. According to a better embodiment of this invention, use prediction vector to predict the bit number after every block is coded and use Lagrangian mode decision method to calculate an initial weight. Then apply to different combination of every block to cooperate with its authority and by choosing codes use the least bytes but the most accurate best motion vector.

According to the above-motioned content, there are the following advantages in this invention:

1. This invention adopts a fixed interval search method to avoid the situation that when shift of the frame content is huge, the conventional fixed location search method might cause distortion.

2. Aiming at plenty of reference frames to search, the embodiment of the present invention can do the first-staged gradually candidate search for each frame. The second stage only needs to find out the better candidates the first stage choose and then search for the best motion vector. By this method, it can save larger calculation amount than the conventional technique.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic block diagram of integral motion estimation method of the preferred embodiment of the present invention;

FIG. 2 is an encoding flow chart of integral motion estimation of the preferred embodiment of the present invention;

FIG. 3 is a flow chart of generating the better motion vector in the first stage of the preferred embodiment of the present invention; and

FIG. 4 is a schematic block diagram of transmitting data bit truncation of the preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

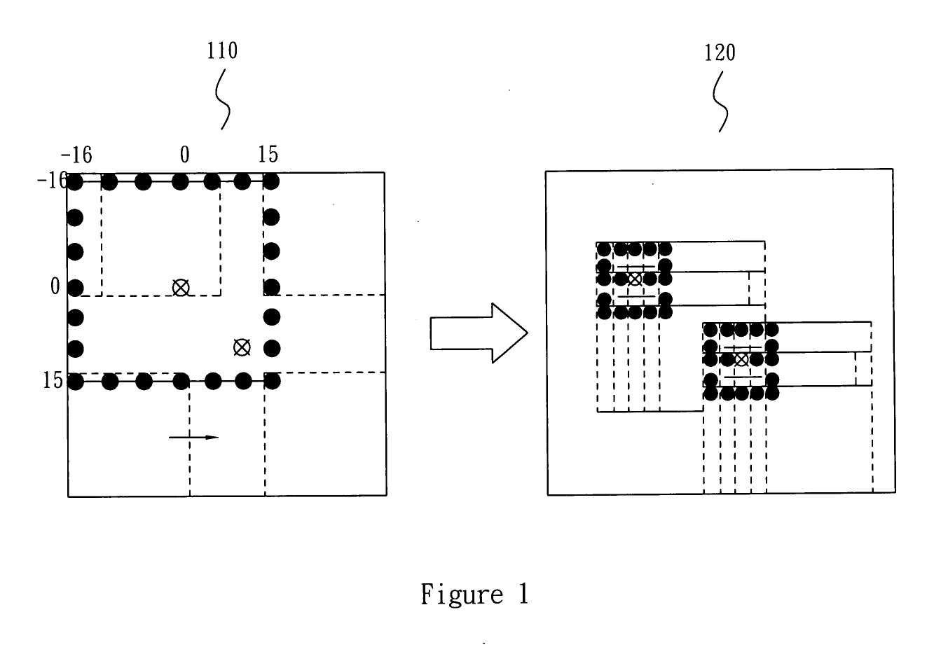

Reference is made to FIG. 1, which shows a schematic block diagram of integral motion estimation method of the preferred embodiment of the present invention. There is a 2-stage integral motion estimation method. At a first phase 110, it proceeds regular search and achieved several motion blocks ones in searching scope. It is the pixel located between −16 and 15, in which better motion block shows up. Then in a second phase 120 try to find out the better motion block where thy really locate to present the included better motion block in the trend.

In the first phase 110, every time is separated a fixed sampling point to carry on a time of search. It takes advantage of this the regular search movement, and greatly saves the access time which because the same data request consumes. After determining several candidates, the motion vectors that approaching the best solution could be obtained efficiently.

Moreover, when the first phase 110 is processing, because of no needs to decide a finally motion vector, therefore it have not to achieve total character accuracy. Which only picks up several higher digits in pixels, then reduces bandwidth request of memory access. In addition, for co-operates a motion vector searching of variable block sizes, the first phase 110 only must calculate a single block. For example, an operation of a 16×16 macroblock mode, above two methods may largely reduce the calculation, and accuracy of the maintaining motion vectors.

The second phase 120, in accordance with several candidates which decided in the first phase 110, carries on a local small range full search. Because the first phase 110 has attained several candidates that approaching the best solution, therefore must make a further search in view of these motion vectors tendencies. Starting from a candidate makes a small range full search, then according to all vectors which search for, discovering the best 4×4 block motion estimation. Finally, selects the best 41 groups of motion vector of several kinds of blocks from the remaining block modes.

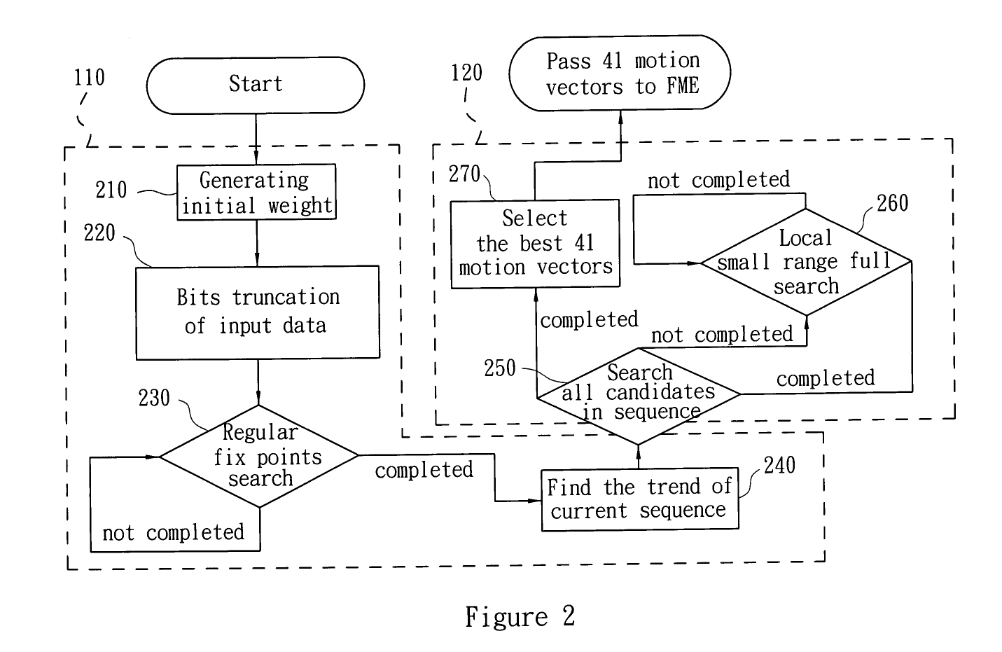

Reference is made to FIG. 2, which shows an encoding flow chart of integral motion estimation of the preferred embodiment of the present invention. When processing data of a macroblock, first, a step 210 includes getting an initial weight in accordance with motion vectors that obtained in the second phase 120, and bit numbers after every block coding that predicted by prediction vectors, and coordinated with Lagrangian mode decision method. A step 220 includes reducing bit numbers of transmitting data of a reference macroblock pixel and a current macroblock pixel, which could reduce hardware cost of chip and save bandwidth for memory accessing. A step 230 includes proceeding with a search for all motion block at every fixed interval in search range continuously. A step 240 includes discovering a dynamic tendency of a current frame, namely several better candidate motion blocks. From the step 210 to the step 240, the first stage 110 has finished. If processing searches of several reference frames is needed, then it must be searched a preceding frame, a frame before the preceding frame and so on, in sequence. Infer from the above operations, until seeking frames are obtained.

In accordance with the several better candidate motion blocks from the first stage 110, processing a small range full search, and obtaining the better motion vectors, which is a purpose of the second stage 120. In a preferred embodiment of the present invention, find the possible best motion tendency from a part of whole search range. So in a step 250, which includes searching every possible candidate in sequence, and a step 260 includes proceeding with a method of small range full search until every possible candidate is being searched. A last step 270 includes finding 41 groups of motion vectors in accordance with H.264 decoding standard. The 41 groups of motion vectors include a group of 16×16 macroblock mode, two groups of 16×8 macroblock modes, two groups of 8×16 macroblock modes, four groups of 8×8 macroblock modes, eight groups of 8×4 macroblock modes, eight groups of 4×8 macroblock modes and sixteen groups of 4×4 macroblock modes. All 41 groups of motion vectors will transmit to fraction motion estimation for next operation.

Reference is made to Table 1, which shows bit numbers generated by a weight generator of the preferred embodiment of the present invention. The bit numbers generated by the weight generator from calculates the prediction code of weight. An embodiment of the present invention uses reference software Joint Model 9.3 for developing a prediction method. The prediction method predicts the present motion vectors could be encoded the bit numbers in Table 1. A search range in Table 1 is 16, which means the search range of pixel is from −16 to +16. In accordance with the bit numbers, the motion vectors, and the Lagrangian mode decision method from H.264 standard encoding process, which could obtain an initial weight.

TABLE 1

| Search Range = 16 | |
|---|---|
| Prediction Difference | Bit Number |
| 0 | 1 |
| 1 | 3 |
| 2~3 | 5 |
| 4~7 | 7 |
| 8~15 | 9 |
| 16~31 | 11 |
| 32~63 | 13 |
| 64~127 | 15 |
| 128~255 | 17 |
| 256~512 | 19 |

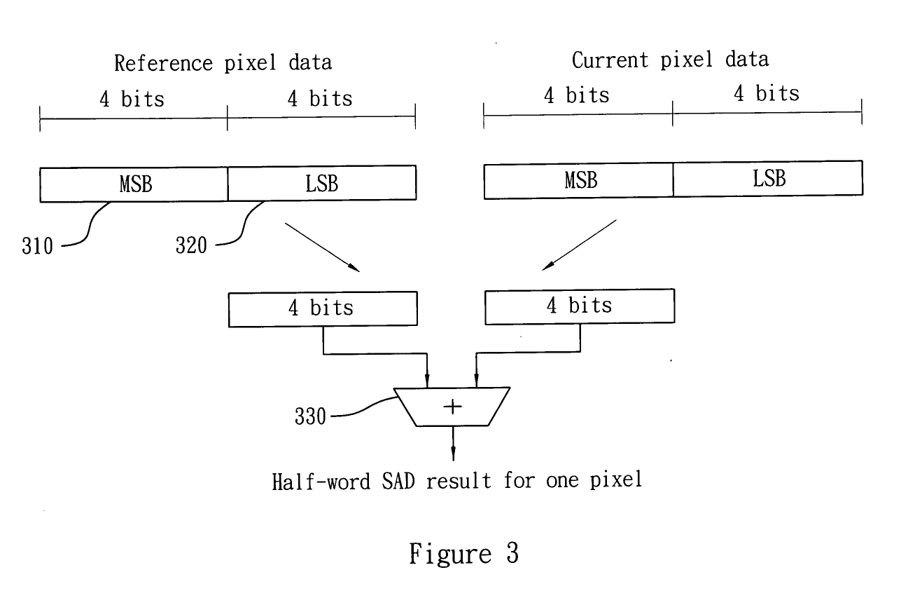

Reference is made to FIG. 3, which shows a schematic block diagram of transmitting data bit truncation of the preferred embodiment of the present invention. An embodiment of the present invention uses the first four bits to be a most significant bit (MSB) 310, and which omits the last four bits named least significant bit (LSB) 320.

A reason of above operation is that quality of a frame has slightly distortion by omitting the LSB 320. If omitting more than four bits, then human's eyes will observe the distortion of frame. And another advantage is the hardware for processing follow-up operations could only use a 4-bits accumulator 330, and need not an 8-bits accumulator. Besides, the access time of accessing from memory at another chip could be reduced for original a half.

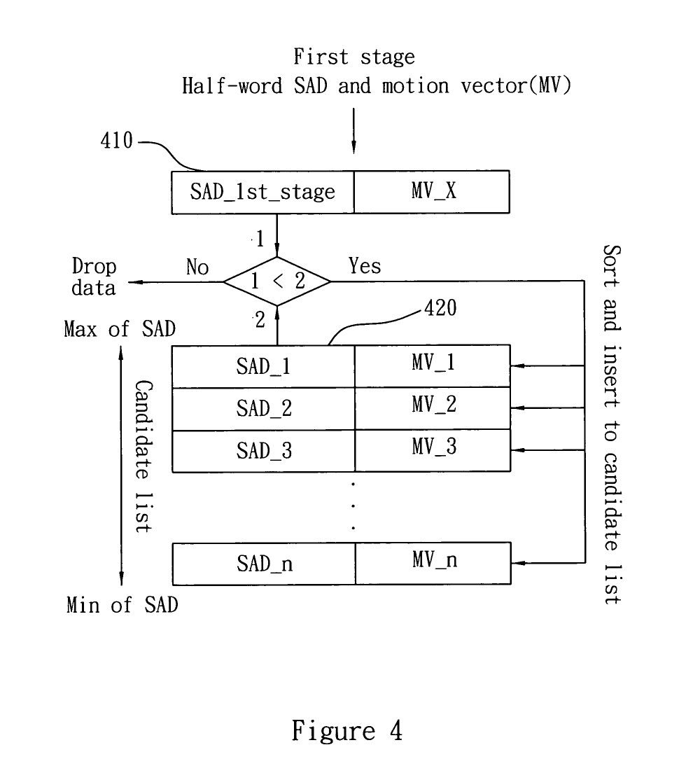

Reference is made to FIG. 4, which shows a flow chart of generating the better motion vector in the first stage of the preferred embodiment of the present invention. First, calculate a sum of absolute difference (SAD), then compare with amount of a SAD 410 which not yet processes and a SAD 420 which in a candidates list. If the SAD 410 is smaller than the SAD 420, then insert the SAD 410 to the candidates list and sort all candidates from possible highest to possible lowest in sequence. And every motion vector corresponded every SAD in the candidates list sorted in sequence by the same way. If there is a better motion vector, then update data of a data buffer immediately. In addition, if the SAD 410 is not smaller than the SAD 420, then drop the SAD 410. After finish searching of full area, a tendency of the present frame could be obtained (Which means finishing the step 240 in FIG. 2).

According the above-mentioned preferred embodiment of the present invention, there are the following advantages if this invention is applied to:

1. The embodiment of the present invention offers a method of searching all possible candidates at fixed interval in a small area. It could obtain the best motion vector and the moving tendency of every candidate. And it could avoid the distortion caused by great motion of content of a frame.

2. Aiming at plenty of reference frames to search, the embodiment of the present invention can do the first-staged gradually candidate search for each frame. The second stage only needs to find out the better candidates the first stage choose and then search for the best motion vector. For example, if search 4 reference frames of every search block, and search 1 point at a fixed interval of 5 points for 4 candidates in the first stage, and search (−2,+2) pixel around the 4 candidates in the second stage, then it only needs (((16*2)/5+1)̂2*4)+4*((2*2+1)̂2)=296 searching times; and a full area search needs ((16*2+1)̂2)*4=4356 searching times. So the embodiment of the present invention could reduce amount of calculation of conventional all area search method to (4356−296)/4356=93%.

3. Because of applying regularly search method of the embodiment of the invention, the same data could be used massively. The method could reduce enormously action of memory accessing and lower requirement of memory bandwidth from system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An method for video decoding, comprising:
(a) applying a search at a plurality of candidates from fixed interval in a frame, the search obtaining a plurality of candidate motion blocks; and
(b) applying a small range full search in accordance with the plurality of candidate blocks of step(a), and obtaining 41 groups of motion vectors of various kinds of blocks.

2. The method for video decoding of claim 1, wherein the search of step(a) comprises a method for calculating an initial weight.

3. The method for video decoding of claim 2, wherein the method for calculating an initial weight comprises at least one prediction vector and a Lagrangian mode decision method.

4. The method for video decoding of claim 3, wherein the prediction vector means for predicting a bit number of a block is encoded.

5. An method for video decoding, comprising:
(a) applying a search at a plurality of candidates from fixed interval in the plurality of reference frames, the search obtaining a plurality of candidate motion blocks; and
(b) applying a small range full search in accordance with the plurality of candidate blocks of step(a), and obtaining 41 groups of motion vectors of various kinds of blocks of the plurality of reference frames.

6. The method for video decoding of claim 5, wherein the search of step(a) comprises a method for calculating an initial weight.

7. The method for video decoding of claim 6, wherein the method for calculating an initial weight comprises at least one prediction vector and a Lagrangian mode decision method.

8. The method for video decoding of claim 7, wherein the prediction vector means for predicting a bit number of a block is encoded.
